(19) United States
(12) Patent Application Publication
(10) Pub. No.: US 2002/0014564 A1
(43) Pub. Date: Feb. 7, 2002

(54) Height adjustable table leg

(76) Inventors: Jason D. Erikson, Durant, IA (US); Craig H. Schultz, Muscatine, IA (US); Michael J. Bell, Davenport, IA (US)

Correspondence Address: Russell L. McIlwain, Jones, Day, Reavis & Pogue, 77 West Wacker, Chicago, IL, 60601, US

(21) Appl. No.: 09/862,768

(22) Filed: May 21, 2001

Related U.S. Application Data
(60) Provisional application No. 60/209,938, filed on Jun. 7, 2000.

(51) Int. Cl. F16M 11/24

(52) U.S. Cl. 248/188.2

(57) ABSTRACT

The present invention provides a height adjustable table leg including an upper housing attachable to an underside of a table and being formed with an upper tubular portion. A lower tube member is dimensioned and configured to be telescopingly received by the upper tubular portion. A cam member is pivotably mounted to the upper tubular portion and selectively cooperates with an undulating strip attached to the lower tube member in one of a plurality of telescoped positions relative to the upper tubular portion.

### CROSS-REFERENCE TO RELATED APPLICATIONS

Priority is claimed from Provisional Application Serial No. 60/209,938, filed Jun. 7, 2000.

### BACKGROUND OF THE INVENTION

1. Field of the Invention

The present invention relates generally to the construction of a table leg and, more particularly, to a table leg that is conveniently manually adjustable in height to permit an associated table top to be positionable at any one of a range of heights.

2. Description of the Related Art

Tables are used in a wide variety of applications to support various objects or serve as work or other activity surfaces, for example. It is sometimes desirable to provide a table with height adjustable legs such that the table top can be raised or lowered to a particular desired height. Such a table can thereby be adjusted, for example, to match the height of an adjacent table top or other surface. It is also sometimes desirable to provide height adjustable tables which can be stored underneath one another to free up surrounding space when the tables are not in use.

A typical form of a height adjustable table is one, for example, having telescoping legs. However, as heretofore known such legs are usually adjusted by means of removing and replacing nuts and bolts in various positions of holes provided in the legs. Such an operation is by its nature time consuming and usually involves the use of tools.

Accordingly, it is desirable to provide a height adjustable leg for a table which can be conveniently adjusted through a range of heights without the need for tools. It is further desirable to provide such a table leg which employs a mechanism that positively locks the leg at the desired height and contributed to a stable table assembly. Still further it is desirable to provide a height adjustable table leg assembly which is cost effective to produce in manufacture.

### SUMMARY OF THE INVENTION

The present invention improves over the prior art by providing a height adjustable table leg including an upper housing attachable to an underside of a table and being formed with an upper tubular portion. A lower tube member is dimensioned and configured to be telescopingly received by the upper tubular portion. A cam member is pivotably mounted to the upper tubular portion and selectively cooperates with an undulating strip attached to the lower tube member in one of a plurality of telescoped positions relative to the upper tubular portion.

### BRIEF DESCRIPTION OF THE DRAWINGS

The foregoing and other novel features and advantages of the invention will be understood upon a reading of the following detailed description taken in conjunction with the accompanying drawings wherein:

FIG. 1 is a right rear perspective view of a table leg constructed in accordance with the principles of the invention;

FIG. 2 is a right front perspective view of the table leg;

FIG. 3 is a rear elevational view of the table leg;

FIG. 4a is a cross-sectional view taken along the line 4-4 of FIG. 3 showing the adjustment lever in an engaged position; and

FIG. 4b is a cross-sectional view taken along the line 4-4 of FIG. 3 showing the adjustment lever in a disengaged position.

### DETAILED DESCRIPTION OF THE PREFERRED EMBODIMENT

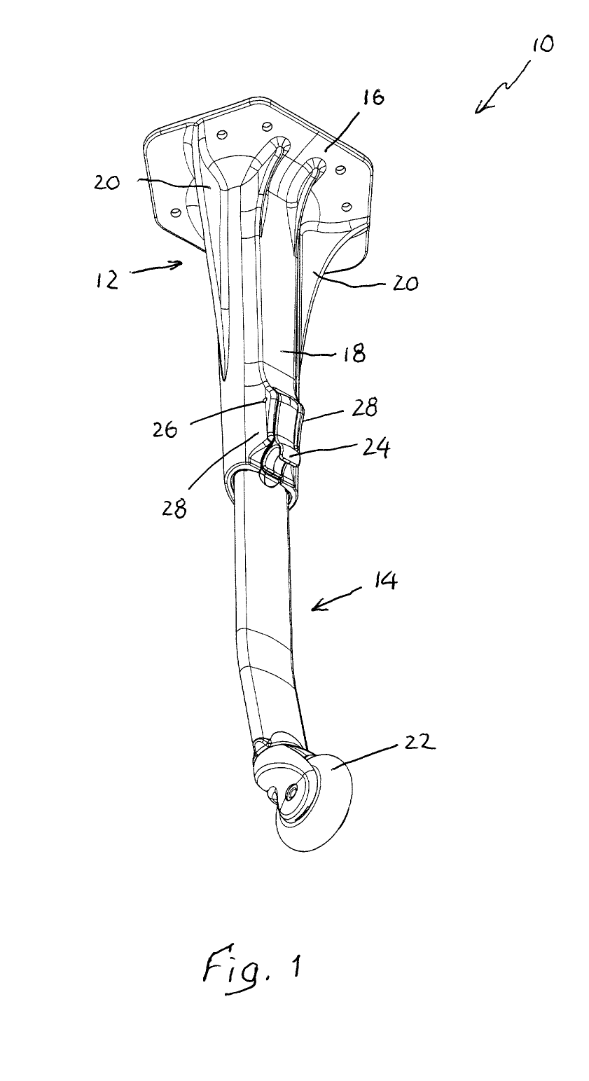

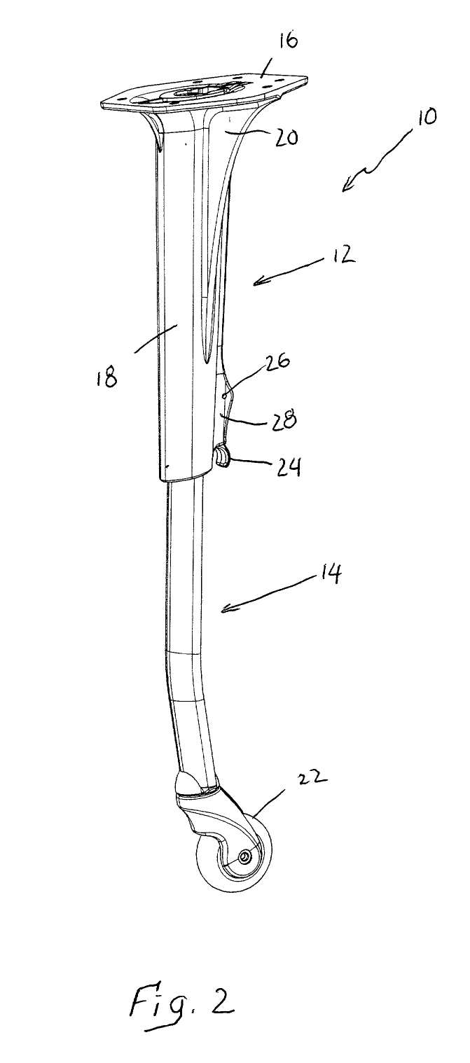

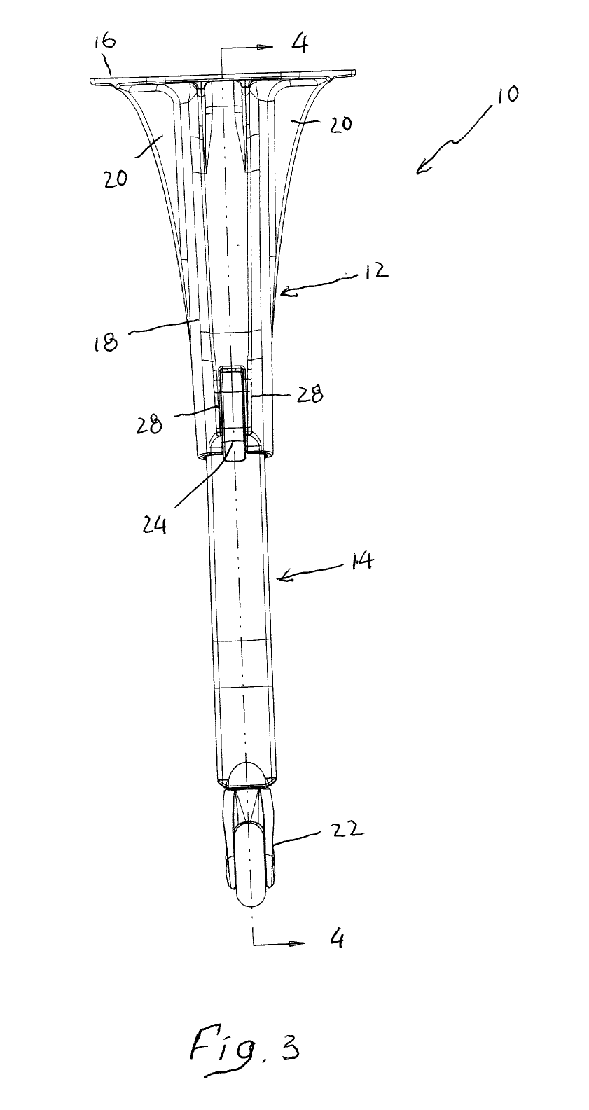

Referring now to the drawings, and initially to FIGS. 1-3, a table leg constructed according to the invention is designated generally by the reference numeral 10 and includes as its principal components an upper housing 12 and a tube member 14. The upper housing 12 is preferably formed from cast metal as an integral structure including a generally hexagonal mounting plate 16 from which a tubular section 18 extends. The tubular section 18 and tube member 14 are generally triangular in cross-section such that the tube member 14 can be telescopingly received by the tubular section 18 but is restricted from relative rotation therein. Suitable gussets 20 may be provided to strengthen the housing 12. A caster 22 may be provided if desired on the bottom end of the tube member 14. As best seen in FIG. 1 a pivotable adjustment handle 24 is mounted by a pin 26 to a pair of spaced flanges 28 projecting from the tubular section 18 of the housing 12.

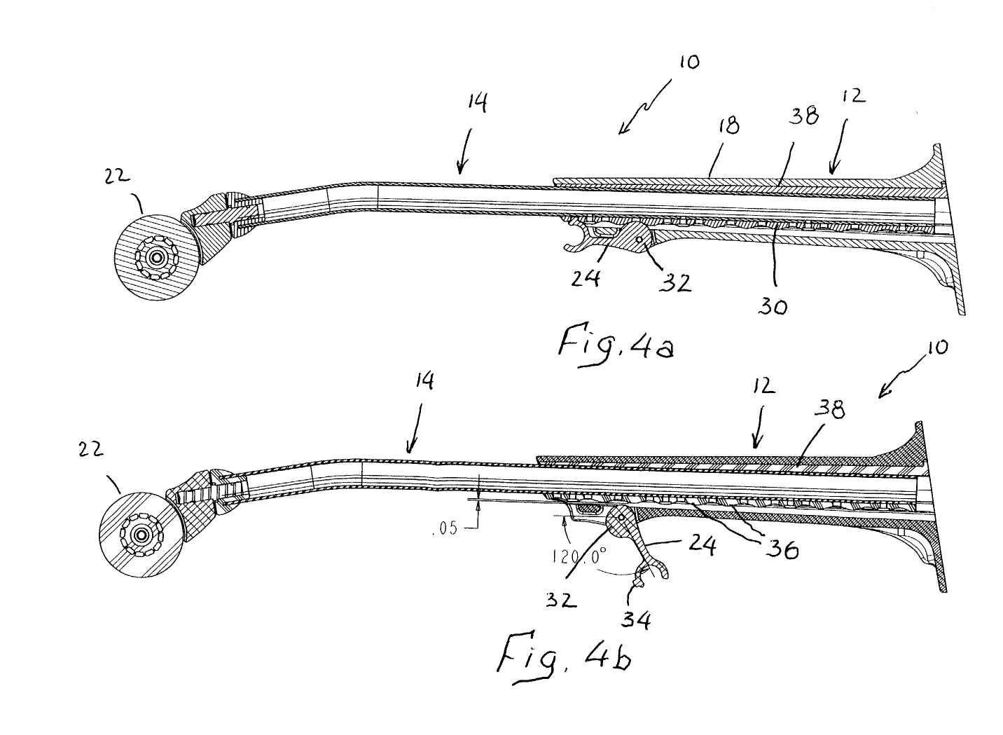

Turning now to FIGS. 4a and 4b, the tube member 14 can be seen to include an undulating strip 30 attached to a rear side of the tube member 14. The strip 30 may be formed from plastic and configured to have peaks and valleys alternating in height from ¼ inch to ⅛ inch every inch of its length. The handle 24 has a cam portion 32 which as best seen in FIG. 4a cooperates with the strip 30 to frictionally lock the tube member 14 at any one of several positions relative to the housing 12. To further lock the tube member 14, and as best seen in FIG. 4b, the distal end of the handle 24 may also be provided with a projection 34 which is received by one of a series of apertures 36 in the strip 30. The housing 12 may be provided with a plastic insert 38 fitted into the tubular section 18 to avoid metal-to-metal contact of the tube member 14 and section 18.

It can now be appreciated that a table leg 10 constructed according to the invention offers considerable advantages where it is desired to have a conveniently manually adjustable height table. In a preferred form of the invention, the strip may be approximately 12 inches long with undulations every one inch thereof. Thus, a leg according to a preferred form of the invention can be adjusted in one-inch increments from 27 inches long to 34 inches long. Thus, the leg is suitable to provide a table top that can be used in both a sit-down and stand-up mode. Further, selected legs may be conveniently adjusted to provide a slanted work surface if desired. The construction of the present locking mechanism is such that a positive, reliable system for locking is also achieved.

While the present invention has been described in connection with preferred embodiments, it will be apparent to those skilled in the art that many changes and modifications may be made without departing from the true spirit and scope of the invention. Accordingly, it is intended by the appended claims to cover all such changes and modifications which come within the spirit and cope of the invention.

What is claimed is:

1. A height adjustable table leg comprising:
an upper tubular member;
a lower tubular member telescopingly received within the upper tubular member;
an undulating strip attached to the lower tubular member; and
a cam member pivotably supported on the upper tubular member
said cam member dimensioned and configured to selectively engage an undulation of said strip to lock said lower tubular member to said upper tubular member.

2. The table leg of claim 1 wherein said upper tubular member comprises a portion of an upper housing attachable to an underside of a table top.

3. The table leg of claim 1 wherein said strip is formed of plastic.

4. The table leg of claim 1 wherein said cam member is formed integrally with a manually operable handle.

5. The table leg of claim 1 wherein the cam member includes a pin and said pin is cooperable with an aperture formed in said strip to further lock said lower tubular member to said upper tubular member.

6. The table leg of claim 1 wherein said strip is approximately twelve inches in length.

7. The table leg of claim 1 wherein said strip is formed with a repeating configuration of undulations each spaced approximately one inch apart.

8. A height adjustable table leg comprising:
an upper housing formed integrally with an upper tube portion, said housing being attachable to an underside of a table top;
a lower tube member telescopingly received by said upper tube portion;
a cam member having a manually operable handle pivotably supported on said upper tube portion;
a series of undulations provided on said lower tube member, said undulations selectively engageable by said cam member to lock said lower tube member to said upper tube portion in a plurality of telescoped positions of said lower tube member relative to said upper tube portion.

9. The table leg of claim 8 wherein said cam member is formed integrally with a pin an said pin cooperates with one of a plurality of apertures formed in said strip to further lock said lower tube member said upper tube portion.

10. The table leg of claim 8 wherein said strip is formed with a repeating configuration of undulations each spaced approximately one inch apart.
